(19) United States
(12) Patent Application Publication
(10) Pub. No.: US 2008/0133376 A1
(43) Pub. Date: Jun. 5, 2008

(54) SYSTEMS AND METHODS FOR SINGLE STEP PURCHASING OF CONTENT

(76) Inventor: Evan M. Hill, Sandy, UT (US)

Correspondence Address: STOEL RIVES LLP - SLC, 201 SOUTH MAIN STREET, ONE UTAH CENTER, SALT LAKE CITY, UT, 84111, US

(21) Appl. No.: 11/947,401

(22) Filed: Nov. 29, 2007

Related U.S. Application Data
(60) Provisional application No. 60/868,487, filed on Dec. 4, 2006.

(51) Int. Cl. G06Q 30/00

(52) U.S. Cl. 705/26

(57) ABSTRACT

A user may select a purchase content button input on a broadcast receiver. Upon selecting the input, the broadcast receiver may generate a content purchase request comprising a user identifier and a content item identifier. The user identifier and the content item identifier may be automatically obtained by the broadcast receiver. The request may be transmitted to a content purchase service. The content purchase service may associate the request with a user account and may identify the content to be purchased. User preferences may indicate a content codec, bitrate, delivery method, and payment method. The content purchase service may purchase the content from a content provider using a user specified payment method. The content may be delivered to the user as a download, direct transmission, download and/or purchase link, or on tangible media, such as a compact disc or vinyl record per user preferences.

### RELATED APPLICATIONS

This application claims priority to U.S. Provisional Application No. 60/868,487 entitled SINGLE BUTTON PURCHASING OF RADIO CONTENT filed on Dec. 4, 2006, which is hereby incorporated by reference in its entirety.

### TECHNICAL FIELD

This disclosure relates to systems and methods for purchasing content playing on a broadcast content receiver and, in particular, to systems and methods for allowing a user to purchase content playing on a broadcast receiver in a single step.

### BRIEF DESCRIPTION OF THE DRAWINGS

Additional aspects and advantages will be apparent from the following detailed description of preferred embodiments, which proceeds with reference to the accompanying drawings, wherein:

FIG. 1 is a block diagram of one embodiment of a content purchase service;

FIG. 2 is a flow diagram of a method for single step purchasing of content;

FIG. 3 is a flow diagram of a method for single step purchasing of content;

FIG. 4 is a block diagram of one embodiment of a broadcast content receiver;

FIG. 5 depicts an embodiment of a broadcast content receiver;

FIG. 6 depicts an embodiment of a broadcast content receiver; and

FIG. 7 depicts an embodiment of a broadcast content receiver.

### DETAILED DESCRIPTION OF PREFERRED EMBODIMENTS

The embodiments of the disclosure will be best understood by reference to the drawings, wherein like elements are designated by like numerals throughout. In the following description, numerous specific details are provided for a thorough understanding of the embodiments described herein. However, those of skill in the art will recognize that one or more of the specific details may be omitted, or other methods, components, or materials may be used. In some cases, operations are not shown or described in detail.

Furthermore, the described features, operations, or characteristics may be combined in any suitable manner in one or more embodiments. It will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps or by a combination of hardware, software, and/or firmware.

Embodiments may also be provided as a computer program product including a computer-readable medium having stored thereon instructions that may be used to program a computer (or other electronic device) to perform processes described herein.

The computer-readable medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of media/machine-readable medium suitable for storing electronic instructions.

Several aspects of the embodiments described will be illustrated as software modules or components. As used herein, a software module or component may include any type of computer instruction or computer executable code located within a memory device and/or transmitted as electronic signals over a system bus or wired or wireless network. A software module may, for instance, comprise one or more physical or logical blocks of computer instructions, which may be organized as a routine, program, object, component, data structure, etc. that performs one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

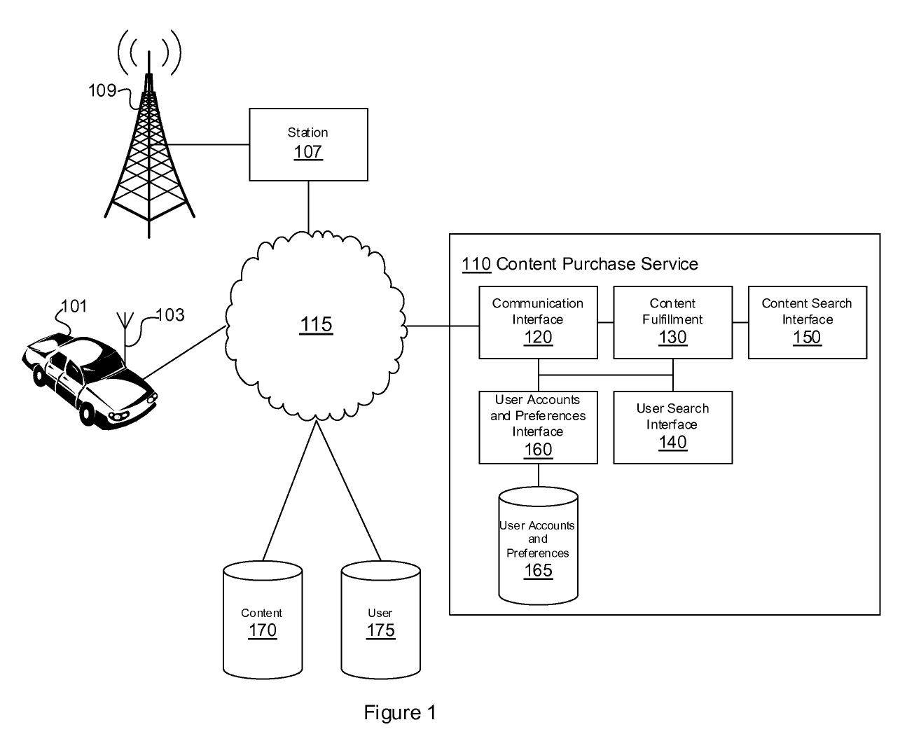

Turning now to FIG. 1, a block diagram of one embodiment of a content purchase service 110 is depicted. A user 101 may access content broadcast by a radio station 107 via a transmitter 109 via a radio receiver 103. In one embodiment, the broadcast transmitter 109 may produce a frequency modulated (FM), amplitude modulated (AM), and/or high-definition radio (e.g., HD Radio®) radio frequency (RF) signal or the like. As such, user 101 may access the broadcast content using an RF receiver. In another embodiment, transmitter 109 may comprise a satellite transmitter 107, such as that used in an XM® and/or Sirius® satellite radio service. As such, receiver 103 may comprise a satellite radio receiver. In another embodiment, the transmitter may be a television, video, and/or multimedia content broadcaster. In the depicted embodiment, the broadcast content item may comprise video and/or multimedia content.

Station 107 may broadcast program content comprising music, talk, video content, multimedia content, or the like. User 101 may receive such broadcast content via radio receiver 103. User 101 may identify a portion of the received program content (e.g., a content item) that he or she would like to purchase for access at a later time. Such purchase may comprise obtaining a licensed copy of music, talk, or other content.

Radio receiver 103 may comprise an input (not shown) to allow the user 101 to make such a purchase. Upon selecting this input (not shown), an application running in conjunction with the radio receiver 103 and/or communicatively coupled to the radio receiver may transmit a content purchase request to a content purchase service 110.

The content purchase request may comprise the time the user selected the input (i.e., a request timestamp), the selected station, and/or other content identifying information. The broadcast content may comprise a content item identifier. For example, music content may comprise the track name, artist, and album and television content may comprise an episode name and number. If such information is available, it may be included in the content purchase request. Location coordinates of the selected station (e.g., the station 107 transmitter 109 and receiver 103 is tuned to at the time of the request) including Global Positioning System (GPS) location coordinates, may be included in the content purchase request. Such information may be used by content purchase service 110 to identify the desired content item for purchase.

The content purchase request may be transmitted to content purchase service 110 via network 115. Network 115 may comprise any communications network known in the art including, but not limited to: a local area network (LAN); a wide area network (WAN); a Wireless Fidelity® and/or Wi-Fi network; the Internet; or the like. Accordingly, it should be understood that this disclosure, and specifically network 115, is not limited to any particular communication method and/or protocol, and that the teachings of this disclosure may be implemented using any communications method and/or protocol known in the art.

The content purchase request may be transmitted from the radio receiver 103 and/or application communicatively coupled to the radio receiver 103 (not shown). As discussed above, the content purchase request may be transmitted using any network communication method and/or protocol known in the art. The transmission may occur when the user selects a purchase content input (not shown). Alternatively, the request may be stored to be transmitted at a later time (e.g., when the application (not shown) comes within wireless network 115 range and/or is otherwise connected to a network 115).

Content purchase service 110 may receive the content purchase request via communications interface 120. Communications interface 120 may be communicatively coupled to network 115. Communications interface 120 may receive the content purchase request and forward it to content fulfillment module 130. Content fulfillment module 130 may identify a user 101 associated with the purchase request and may identify the content to be purchased.

Content fulfillment module 130 may obtain a user identifier from the content purchase request. Content fulfillment module 130 may send this identifying information to user search interface 140. User search interface 140 may search one or more user database(s) 175 to identify and access a user account associated with the user identifier. Alternatively, the user identifier may include a unique identifier of the user account.

The user account accessed by user search interface 140 may comprise user preferences including payment and/or preference information relating to the content purchase request. The user account determined by user search interface 140 may be managed by a third-party and may not be directly affiliated with content service 110. In an alternative embodiment, content purchase service 110 may comprise a user account and preferences management component 165. In this embodiment, content fulfillment module 130 may query user account and preferences component 165 to determine a local user account and preferences data store 165.

The user account determined by user search interface 140 may be used by content fulfillment module 130 to complete a content purchase transaction. Such information may comprise payment preferences, delivery and/or provisioning preferences (e.g., file format, delivery, etc.), and the like. Alternatively, a combination of the user account determined by user search interface 140 and one or more user preferences stored in user account and preferences 165 may be used, or user account information and preferences (e.g., payment preferences and provisioning preferences) may be stored in content purchase service 110 in user account and preferences 165.

Content purchase service 110 may comprise a user account and preferences interface 160 to allow user 101 to manage information in user accounts and preferences data store 165. Interface 160 may comprise a network accessible application (e.g., a web-browser interface). Interface 160 may allow a user 101 to add and/or modify user the user preferences discussed herein (e.g., preferences relating to payment, delivery, codec, digital rights management (DRM), and the like).

Content fulfillment module 130 may obtain a content item identifier from the content purchase request. Content fulfillment module 130 may send this identifying information to content search interface module 150. As discussed above, the content item identifier may comprise an artist, track, and/or album name or may comprise other information, such as a television program identifier, series number, or the like. The content purchase request may include the time the request was made (i.e., a content purchase request timestamp), a broadcast station 107 identifier (e.g., broadcast frequency, channel, and/or call letters), and/or location coordinates (e.g., GPS coordinates) indicating the location of the receiver 103 when the request was made. Content search interface module 150 may be configured to search one or more content database(s) 170 and/or online store(s) 170 (i.e., content providers) to find a source for the requested content.

Content search interface may query broadcast station 107 to identify the requested content. Where the artist, track, album, program name, or other identifier of the broadcast content information is not available, content search interface may determine a broadcast station 107 associated with the request from the content item identifier (e.g. broadcast station 107 name, frequency, and/or call letters) and/or location coordinates. The location coordinates may allow content search interface 150 to distinguish between stations operating on similar frequencies and/or call letters. For example, the same station frequency and/or call letters (e.g., 101.9 MHz and/or KXRK) may be used by different stations in different geographical regions. As such, GPS coordinates may be used to differentiate between such similar stations.

After identifying the broadcast station 107, content search interface 150 may issue a query to the broadcast station 107 to determine a playlist at the time the user content purchase request was issued. In this embodiment, station 107 may be communicatively coupled to network 115 and/or station 107 may provide a playlist service communicatively coupled to network 115. This may allow content search interface 130 to identify the content associated with the content purchase request (e.g., the content playing on a particular frequency and/or channel at a particular time in a particular region).

After identifying the requested content item for purchase, and a user account associated with the request, content fulfillment module 130 may complete the transaction. This may be done in a number of ways. For example, a copy of the content item may be transmitted over network 115 to the receiver 103 of user 101. This approach may be used where the receiver 103 comprises data storage and/or is communicatively coupled to network 115. In an alternative embodiment, and in accordance with user preferences, the requested content may be delivered to another location and/or device through network 115 (e.g., a media center, computer system, or the like). Alternatively, a download credit for the requested content may be provisioned to the user 101. In this case, user 101 may be provided with a link to download the content from a content provider (e.g., online content store, such as iTunes®, Amazon® or the like). As used herein a content provider may refer to a music store, a video store, or any other rights holder capable of making digital and/or tangible content available to consumers. The link may be provided via an email message, SMS message, or the like. In another example, the requested content item may be downloaded to receiver 103 and/or another device associated with user 101 via transmitter 109. Alternatively, receiver 103 may comprise data storage and may have stored a copy of the content item thereon. In this case, purchasing may comprise unlocking the content item or otherwise making the content item available for subsequent playback and/or transfer to another device. Where a user prefers a physical copy of the content, the content item may be provided via tangible media delivered on a compact disk (CD), memory stick, vinyl record, or the like.

The content purchase transaction may be controlled by user preferences stored in a user account data store 175 and/or user account and preferences data store 165. These preferences may determine the preferred purchase format (e.g., codec, bitrate, delivery means, etc.). Responsive to these preferences, content search interface 150 may obtain an appropriate copy of the content item (e.g., Motion Pictures Experts Group (MPEG)-1 audio layer 3 (MP3) encoding at 160 bits per second (bps)). If the content item is not available in the requested format, content fulfillment module may be configured to convert the content item into the preferred format and/or codec. Where such conversion is not possible (e.g., the user has requested a higher bitrate than what is available), the closest available format may be provisioned and/or the transaction may be cancelled depending upon user preferences.

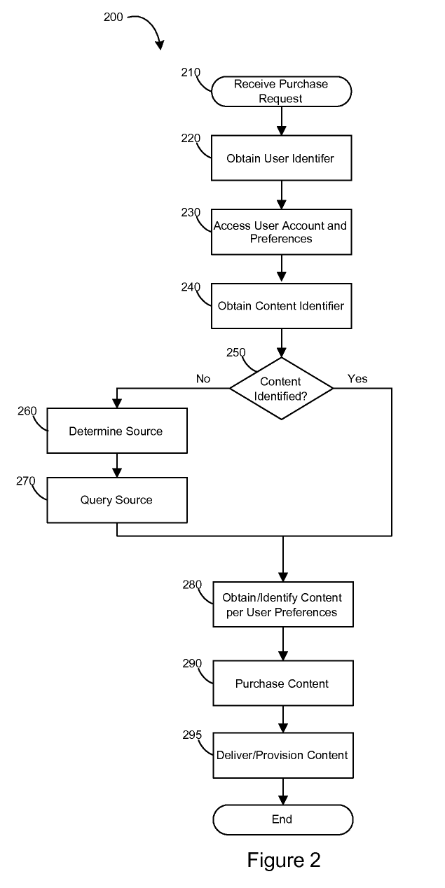

Turning now to FIG. 2, a flow diagram of a method 200 for purchasing content is depicted.

At step 210, a content purchase request message may be received. As discussed above, the content purchase request message of step 210 may be received via a communications network comprising any communications protocol and/or infrastructure known in the art.

At step 220, a user identifier may be obtained from the content purchase request message. A user identifier may include, but is not limited to, a media access control (MAC) value associated with the message, a user identifier, a personal identifier number (PIN), a hardware identifier, or the like. The user identifier may be automatically obtained and added to the content purchase request message by the message transmitter (e.g., device originating the request).

The identifying of step 220 may comprise user authentication and/or user verification. For example, the request of step 210 may be transmitted via a secure communications channel, such as secure sockets layer (SSL). As such, the identity of the sender may be authenticated via the communication protocol used at step 210. In another embodiment, a user identifier may comprise a timestamp/hash and/or some other credential, such as a Security Assertion Markup Language (SAML) authentication assertion or the like. The credential and accompanying information may be used to authenticate the user identifier associated with the content purchase request message to verify that the message was sent and/or authorized by the identified user. One skilled in the art would recognize that any user identifier, verification, and/or authentication means could be used under the teachings of this disclosure. As such, this disclosure should not be read as limited to any particular user identifier and/or authentication technique and/or methodology.

At step 230, a user account associated with the user identifier obtained at step 220 may be accessed. The user account may be provided and/or managed by a third-party. In this case, the user identifier, including authentication credentials obtained at step 220, (and/or credentials derived therefrom) may be used to access the user account. For instance, a SAML authentication assertion may be generated and passed to the third-party account provider to authenticate method 200 on behalf of the user or otherwise request user attributes, such as payment and content provisioning preferences. In another embodiment, the user account may be managed and stored by method 200. Such a user account system may comprise a relational database, an X509 directory, a lightweight directory access protocol (LDAP) directory, or the like.

The user account accessed at step 230 may specify user preferences relating to content purchases. Such user preferences may include a preferred payment method or methods, preferences relating to content format (e.g., codec, bitrate, or the like), preferred content delivery mechanism, or the like.

At step 240, a content item identifier may be obtained. For music content, a content item identifier may include an artist name, track, and album (if available). For television and/or video content, the content item identifier may comprise an Internet Movie Database (IMDB) name, a program and/or show name, an episode number and/or series number, or the like. Alternatively, the identifier may comprise a station identifier, such as a broadcast frequency, call letters, or the like. The station identifier may further include location coordinates (e.g., GPS coordinates) and a timestamp. In still other embodiments, the identifier may comprise a file name, record number, or other type of identifying information. If the content item identifier definitively identifies the content (e.g., includes an artist and track name, show name, movie name, or the like), the flow may continue to step 280. If the identifying information comprises a broadcast station identifier and timestamp or other indirect identifying information, the flow may continue to step 260.

At step 260, a source of the content item may be determined. As discussed above, in one embodiment, the source of the content item may be a broadcaster, such as a radio station, television station, or the like. In this case, the content item identifier may comprise a broadcast frequency and/or station call letters. The identifying information may further comprise GPS coordinates or some other means for determining a location associated with the request. This information may be used to identify a broadcast station associated with the request. Alternatively, the identifying information may comprise a URL (if the broadcast is an Internet or communications network broadcast) or any other station identifying information.

At step 270, the broadcaster and/or a database associated with the broadcaster may be queried to identify the requested content item. The query may comprise a timestamp or some other identifier to associate the request with content disseminated by the broadcaster. For example, some broadcasters may make playlist and/or program scheduling information available and/or provide a service whereby such information may be accessed. In this case, given the timestamp, or other identifying information, the content item may be identified from the playlist. Alternatively, a music licensing organization, such as the Radio Music Licensing Committee (RMLC), the American Society of Composers, Authors and Publishers (ASCAP), or the like may maintain and/or otherwise make available broadcaster playlist information for licensing and loyalty purposes. In this case, the content item may be identified by querying such a list with a station identifier and time information. The query of step 270 may result in multiple possible content item selections rather than a single content item. In this case, user preferences may direct the system to select the most likely content selection given the user's past purchase history and/or may allow the user to identify the desired content item selection at a later time (e.g., in a selection list and/or shopping cart as described below).

At step 280, the content item may be obtained or otherwise licensed for use by the user. The type of content obtained may depend upon user preferences. For example, the user preferences may indicate that the user would prefer to receive content encoded using a particular codec including, but not limited to: MP3; Ogg; Windows Media Audio (WMA); Advanced Audio Coding (AAC); Free Lossless Audio Codec (FLAC); DivX®, Windows Media Video (WMA), or the like. Similarly, the user preferences may indicate a preferred bitrate associated with one or more preferred codecs (e.g., an MP3 encoded at 160 bits per second (bps)). The user preferences may further indicate a codec preference order (e.g., prefer FLAC but, if not available, use MP3 then Ogg). User preferences may indicate that content encoded in a particular codec should never be purchased. Such a preference may be used where the user has a particular device (e.g., Apple iPod®, Zune®, or the like), that is not capable of playing content of a particular format and/or codec. As discussed above, where possible (and legally feasible) the content purchasing service may convert a content item into another codec per user preferences (e.g., convert MP3 content to WMA).

User preferences may specify a preferred source for the content item (i.e., a preferred content provider). The content purchase service of this disclosure may be configured to interact with various content providers including, but not limited to: iTunes®; Microsoft® Urge®; Amazon® music; Wal-mart® music; Yahoo® music, or the like. In addition, the content purchase service of this disclosure may interact directly with music publishers including, but not limited to: Sony BMG®; EMI®; or the like. Various suppliers and/or publishers may have different pricing structures, DRM systems, available codecs and/or bitrates, or the like. As such, a user may prefer one content provider over another. Accordingly, the user preferences may indicate a preferred content provider in an ordered list comprising preferred content providers. Along with the content provider preferences, user preferences may indicate a preferred and/or maximum price the user is willing to pay for content. The price may be a price range and/or maximum price accrued across multiple purchases within a particular time period (e.g., maximum expenditure per month).

User preferences may comprise DRM preferences. For example, the user may prefer to purchase content that does not include DRM. This may, however, require the payment of an additional fee or otherwise may affect the pricing and/or availability of content. As such, the user preferences may specify that, if no DRM-free version is available, the transaction should be cancelled. Alternatively, the user preferences may indicate that DRM content is acceptable if no alternative source is available. Similarly, user preferences may indicate a maximum price differential between DRM and non-DRM content. For example, if the non-DRM content is significantly more expensive, user preferences may indicate that the DRM content should be obtained instead.

The user preferences may comprise payment information, such as a credit card number, PayPal® account identifier and credential, bank account information, or the like. The payment information may be used to pay a content provider for the requested content item. The user preferences may include a payment preference order such that if a first credit card is denied and/or has expired, a second credit card and/or an alternative payment method may be used to complete the content purchase.

After a particular content provider has been identified, the content item may be purchased and/or licensed at step 290. Purchasing and/or licensing the content item may comprise charging a user's credit card or by some other payment method (e.g., PayPal®, bank account, or the like) and transferring a portion of the payment to the content provider.

At step 295, the purchased content item may be delivered or otherwise provisioned to the user. User preferences obtained at step 230 may determine the delivery and/or provisioning method. As discussed above, the user may direct that the content item be automatically delivered to a home media center. As such, the content item may be transmitted to the specified device. In another embodiment, the user may have a portable device (e.g., a car audio system, a portable music player, or the like). The device may be communicatively coupled to network (e.g., the audio player may be part of a communications device, such as a cellular and/or network telephone). As such, the content item may be transmitted directly to the device at step 295.

The target device, specified by user preferences, may be intermittently connected to a network. For example, a portable audio player may be occasionally synched with a computing device and/or home media center and/or a communications device that is intermittently within and outside of wireless communications range. In this case, step 295 may queue the content item for download at a later time. When the target device is connected to a network either for synching or via a wireless (or wired) network, the content item may be transmitted to the device. Process 200 may be configured to actively ping the device to determine when it is available and then to automatically “push” the content item to the device, Alternatively, the target device may be configured to poll the content purchase service when connected to the network and download the purchased content item.

User preferences may comprise delivery preferences indicating that the user would prefer to manually download the content item directly from the content provider (e.g., iTunes®). As such, the delivery of step 295 may comprise completing a purchase at the content provider and sending the user a link where the user may obtain the content item.

In another case, the user may not be charged (i.e., the transaction may not be completed), until the user accesses the content provider and completes the transaction. This may give the user an opportunity to review a portion of the content item again to decide whether to complete the purchase. The content provider may manage a list of such content and/or the content list may be associated with a user account and/or transferred to the content provider upon request by the user. Similarly, where multiple possible content items were identified at step 270, the list and/or user account may be populated with all of the identified content items to allow the user to select the desired content item therefrom. The content purchase service may have a relationship with one or more content provider(s). In this case, the content selections may be pushed to a content provider(s) to thereby generate a content selection list (e.g., a selection list on iTunes®, Amazon® music or the like may be created) and/or the content selections may be placed into an online shopping cart or other selection mechanism of the content provider.

User preferences may comprise preferences indicating that the user would prefer to have the content item digitally delivered to a user account and/or network accessible storage location, such as an email account, an Xdrive® account, or the like. In this case, the delivery/provisioning of step 295 may comprise transferring the content item to a user-specified network accessible storage location.

Alternatively or in addition, user preferences may comprise preferences indicating that the user would prefer to have a tangible copy of the content item, such as a compact disk (CD), cassette tape, vinyl record, or the like. In this case, the deliver/provisioning of step 295 may comprise mailing or causing a provider to mail a physical copy of the content item to an address specified by the user.

In some cases, the user may have initially accessed the broadcast content item using a device comprising data storage (e.g., a radio, television and/or satellite receiver comprising disk or other data storage means). In this case, the user may already have a copy of the content item on the device. This content item may not be of the quality the user prefers (e.g., a lower bitrate and/or codec) according to user preferences. If the stored content item is unacceptable, the content item may be delivered at step 295 substantially as described above. If the content item is acceptable per user preferences, however, the delivery and/or provisioning of step 295 may comprise unlocking or otherwise making the stored content item on the user's device available for subsequent access and/or transfer from the device. As such, delivery of step 295 may comprise simply transmitting a license and/or key to unlock the stored content item.

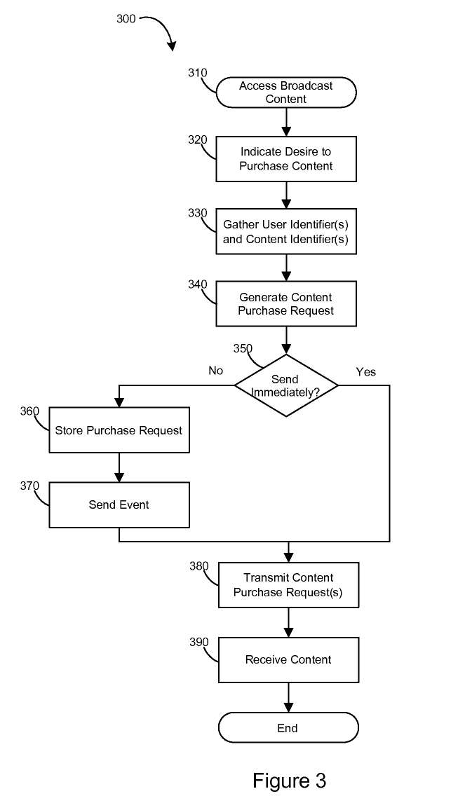

Turning now to FIG. 3, a flow diagram of a method 300 for purchasing content on a receiver device is depicted.

At step 310, a user may use a receiver to access broadcast content. As discussed above, the receiver may be any broadcast content receiver known in the art including, but not limited to: an FM receiver; an AM receiver; high definition (HD) radio receiver; a satellite radio receiver; a television receiver; a network broadcast receiver (e.g., Wi-Fi); an Internet broadcast receiver; or the like. The receiver used at step 310 to access broadcast content may comprise software and/or hardware configured to execute the remaining steps of process 300. Alternatively, the receiver may be communicatively coupled to a device (e.g., a mobile phone, personal digital assistant (PDA), special or general purpose computing device, or the like) capable of performing the remaining steps of process 300.

At step 320, a user of the device may select a device input to purchase content currently being played on the device. The selection of step 320 may comprise selecting a special-purpose input on the device, such as a “purchase content” and/or “buy now” button input. Alternatively, the input may be a software input, such as a touch screen button, menu selection, or the like. In an alternative embodiment, a device in communication with the receiver (e.g., a cellular phone, PDA, computing device, or the like) may comprise the input. In another embodiment, the broadcast content receiver may comprise an application running in conjunction with the device which may provide a software button and/or map an existing device button to act as a “purchase content” and/or “buy now” input.

At step 330, the broadcast receiver device and/or device in communication with the receiver may gather a user identifier and content item identifier. The user identifier may be set in the receiver device and/or device in communication with the receiver, such as a user name and password, a PIN, a digital certificate, or the like. The user identifier may be set when the receiver and/or device communicatively coupled to the receiver is initially setup. The receiver and/or device communicatively coupled to the receiver may comprise a settings and/or options interface to allow the user identifier information to be edited, added to, or otherwise modified.

At step 330, information identifying the content item may be obtained. Such information may comprise a program name, movie name, track name, artist name, album name, or the like. Alternatively, information relating to the broadcast station, such as the broadcast frequency, call letters, or the like and a timestamp may be obtained. As discussed above, such information may be used to identify the content item from a station playlist, playlist service, licensing authority, or the like. The station identifying information may comprise GPS or other location coordinates. This may allow the receiver of the information to determine a particular broadcast station from a plurality of stations sharing a similar broadcast frequency, channel, and/or call letters. Alternatively, location information may be set as part of the device configuration (i.e., as with the user identifier). Such information may comprise a country identifier (e.g., United States, Canada, etc.), state identifier (e.g., Washington), and/or a zip code (e.g., 90210). In this case, the receiver device and/or device in communication with the receiver may provide an interface whereby the location information may be modified. Alternatively, location information may be obtained via a wireless network (e.g., a cellular telephone network, a radio information network, or the like). One skilled in the art would recognize that any location determining data and/or location determination technique known in the art could be used under the teachings of this disclosure. As such, this disclosure should be not read as limited to any particular station identifying information and/or location identifying information and/or technique.

After obtaining the user and content item identifiers a content purchase request may be generated at step 340. Generating a content purchase request may comprise forming a message comprising the user and content item identifiers. Generating a content purchase request may further comprise providing authentication and/or user validation data in the message. Such authentication and/or validation data may include, but is not limited to: a digital signature; an XML signature; a SAML authentication and/or authorization assertion; a Open ID® credential; a Kerberos® ticket; a password; a password hash (e.g., SHA-1 and/or MD5); a PIN; a user name; or the like. The message may be encrypted using a session and/or long-term encryption key using any encryption technique known in the art including, but not limited to: DES; triple-DES; Advanced Encryption Standard (AES); RC4; Blowfish; or the like. One skilled in the art would recognize that any message authentication, authorization, and/or encryption technique known in the art could be used under the teachings of this disclosure.

At step 350, process 300 may determine when the content purchase request message should be sent. As discussed above, in some embodiments, the receiver device and/or device in communication with the receiver implementing method 300 may be communicatively coupled to a network (e.g., a Wi-Fi, cellular, and/or wired network). In this case, the user may specify (through user preferences associated with method 300), that, when possible, purchase requests be sent when generated. If so, and a network connection is available, the flow may continue to step 380. Otherwise, if the user preferences indicate that purchase requests should be batched and/or periodically transmitted at device synch, and/or the device implementing method 300 is outside of network connectivity range, the flow may continue to step 360.

At step 360, the request may be stored for transmission at a later time. In this case, the device implementing method 300 may comprise data storage means, such as a hard disk, flash memory, optical storage, or the like.

At step 370, an event may occur to allow stored purchase requests to be sent. In one embodiment, the event of step 370 may include, but is not limited to: the device implementing method 300 is communicatively coupled to a network (e.g., is connected to a wireless, Wi-Fi, cellular and/or wired network); coupled to a device having a network connection (e.g., a portable music device may be synched with a personal computer and/or home media center); receives a synch command; reaches a user defined synch time; or the like. Upon completion of event 370, the flow may continue to step 380.

At step 380, the purchase request and/or requests may be transmitted to a content purchase service according to the teachings of this disclosure. The transmission may be performed using any network communications protocol known in the art including, but not limited to: a communications protocol per transmission control protocol/internet protocol (TCP/IP); hyper text transfer protocol (HTTP), secure hyper text transfer protocol (HTTPS); secure sockets layer (SSL), HTTP tunneling; secure shell (SSH); a custom protocol; or the like. The transfer protocol may comprise encryption and/or authentication services (e.g., SSL with mutual authentication). In this case, the content purchase request may not need to be independently authenticated and/or encrypted. However, even where a secure communications channel is used, the content purchase request may be independently authenticated and/or encrypted. If multiple content purchase requests have been stored for transmission, all of the pending purchase requests and/or a sub-set of the stored purchase requests may be transmitted at step 380.

At step 390, the content item may be delivered and/or provisioned to the user. The delivery and/or provisioning of step 390 may comprise any delivery and/or provisioning technique known in the art. The technique used may be controlled by one or more user preferences associated with the user account. As discussed above in conjunction with FIG. 2, the delivery/provisioning of step 390 may comprise: a digital download of the content item; a download link delivered to the user via email, short message service (SMS), or the like; a download onto a general and/or special purpose computing and/or audio entertainment system (e.g., a home media center); direct download to the device implementing method 300 and/or a device in communication with the device implementing method 300; a purchase and/or download link on a content provider; or the like.

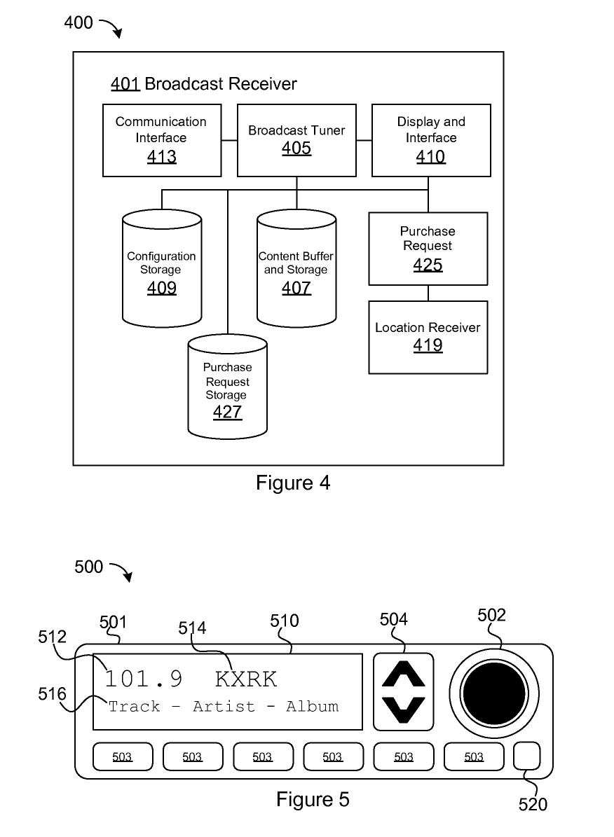

Turning now to FIG. 4, a block diagram of one embodiment 400 of a receiver is depicted. Broadcast receiver 401 may comprise a communication interface 413. Communication interface 413 may be configured to allow broadcast receiver 401 to receive broadcast content (e.g., FM, AM, HD Radio®, satellite radio, or the like). Communication interface 413 may be controlled by broadcast tuner 405 which may determine the station and/or content provider communication interface 413 is tuned to and/or configured to receive. Broadcast tuner 405 may be communicatively coupled to a display and interface module 410 of receiver 401. Interface and display module 410 may allow a user of the receiver to control the operation of the receiver (e.g., tune to various stations and/or content providers).

Receiver 401 may comprise a content buffer and storage module 407. Content buffer and storage module 407 may be configured to store broadcast content as it is received. This may allow a user to pause and otherwise time-shift broadcast content. Content stored on content buffer/storage component 407 may be locked such that a user of receiver 401 may not be able to access the content item without permission from a rights holder (e.g., the user may be unable to playback the content item and/or transfer the content item to another device). However, upon purchasing the content item as taught herein, the content item may be unlocked such that the content item may be played back on receiver 401 and/or transferred from the receiver 401 to another device (not shown).

Receiver 401 may comprise configuration storage 409. Configuration storage 409 may comprise preset station information or the like. In addition, configuration storage 409 may comprise a user identifier according to the teachings of this disclosure (e.g., a user name, password, password hash, PIN, one or more encryption keys, a digital certificate, or the like).

Configuration storage 409 may further comprise a portion of a content item identifier, such as the operating region of receiver 401 (e.g., country, state, zip code, etc.). As discussed above, this information may be used in the generation of content purchase requests according to the teachings of this disclosure. The information in configuration storage 409, including both user and content item identifiers may be modified via display and interface module 410.

Receiver 401 may comprise location receiver 419. Location receiver 419 may be communicatively coupled to a GPS system to determine the location of receiver 401. In other embodiments, location receiver 419 may be communicatively coupled to another location determination service including, but not limited to: a Wi-Fi network; a cellular network; or the like. In some embodiments, location receiver 419 may be part of communication interface 413 (i.e., communication interface 413 may comprise a Wi-Fi, cellular, or other network connection capable of providing location information).

Display and interface module 410 may provide a “purchase content” and/or “buy now” input. This input (not shown) may comprise a push button, a virtual input (e.g., software menu election), a touch screen region, or the like. Selecting the purchase content input (not shown) may cause purchase request module 425 to generate a content purchase request message. The request generated by module 425 may correspond to a content purchase described above in conjunction with FIG. 1-3. As such, it may comprise: a user identifier and a content item identifier obtained and/or derived from configuration storage 409; content (e.g., location information) identifying information from GPS location receiver; content identifying information from broadcast tuner 405 (e.g., artist, track and album name, station, call letters, or the like).

Receiver 401 may be communicatively coupled to a network through communication interface 413. If so, purchase request module 425 may transmit a content purchase request through communication interface 413 as requests are made. Alternatively, content purchase requests may be stored in a storage location 427 to be transmitted later per user preference. Where communications interface 413 is intermittently connected to a network, content purchase requests may be stored in purchase request storage 427 until network communication is achieved. Alternatively, purchase requests may be transmitted using another device (not shown). For instance, receiver 401 may be connected to a computing device, home media center, PDA, cellular phone or the like through communication interface 413. Such connection may be wireless (e.g., Bluetooth, infrared (IR), or the like), or may be wired. When such connection is made, purchase requests in purchase request storage 427 may be transmitted through the other device (not shown) and/or transferred to the device (not shown) for transmission at a later time.

Turning now to FIG. 5, one embodiment 500 of a broadcast content receiver device 501 comprising a content purchase button 520 is depicted. Device 501 may be embodied as a broadcast content receiver capable of receiving FM, AM, HD Radio®, satellite radio, television, multimedia, network, or other broadcast content. Receiver 501 may comprise an on/off and/or volume control 502, one or more preset controls 503, and a tuner control 504. Device 501 may further comprise a display 510. Display 510 may show a tuned station 512 (e.g., 101.9 MHz). In some embodiments, the broadcast content and/or display 510 may be capable of broadcasting and/or displaying call letters associated with the station 514 (e.g., KXRK). In some embodiments, the broadcast station may be capable and/or configured to broadcast content identifying information which may be displayed on region 516 of display 510.

Receiver device 501 may comprise a purchase content input 520. Purchase content input 520 may be configured to cause receiver 501 to generate and/or transmit a content purchase request according to the teachings of this disclosure. Upon selecting input 520, receiver 501 may obtain a user and content identifying information from the device (e.g., tuner and/or stored preferences) and may generate a content purchase request message. The request may be transmitted from receiver 501 using any communications technique known in the art including, Bluetooth, Wi-Fi, IR, or the like. The purchase request may be transmitted directly from receiver 501 (e.g., on a Wi-Fi network) and/or may pass through another device (not shown), such as a cellular phone, computing device, or the like.

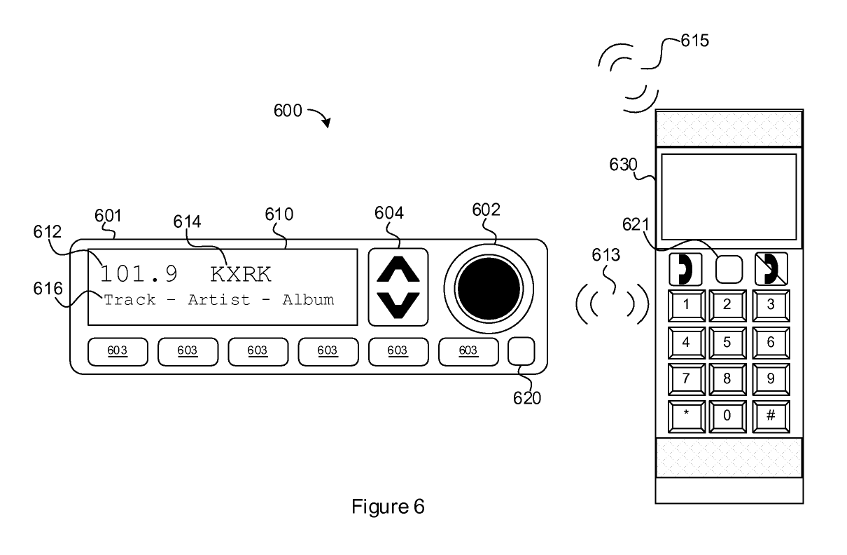

Turning now to FIG. 6, one embodiment of a broadcast content receiver and device according to the teachings of this disclosure is depicted. Receiver 601 may comprise an on/off, volume control 602, a tuner control 604, a plurality of preset buttons 603, and a display 610. Display 601 may be configured to display a station 612, call letters 614, and/or other content identifying information 616. Receiver may be communication with another device 630 via connection 613. Connection 613 may comprise a wired and/or wireless (e.g., Bluetooth, Wi-Fi, IR, or the like) connection.

Receiver 601 may comprise a content purchase input 620. When input 620 is selected, receiver 601 may transmit the user identifier and content item identifier information to device 630. Device 630 may then generate a content purchase request message and transmit the message via network connection 615. In another embodiment, receiver 601 may generate a content purchase request and transmit the request to a device 630 via connection 613. In an alternative embodiment, a content purchase button 621 may be disposed on device 630. In this embodiment, receiver 601 may be a standard off-the-shelf receiver. As such, when the user selects content purchase button 621 of device 630, device 630 may be configured to obtain content identifying information from receiver 601 to thereby generate a content purchase request. For example, device 630 may query or otherwise determine a content identifier of the content presented on receiver 601 and/or may determine a station and/or location information associated with the content presented on receiver 601. In this case, device 630 may comprise user identifying information and, as such, may be configured to generate a content purchase request comprising the content identifier and user identifier. Device 630 may transmit the purchase request via network connection 615.

In one embodiment, upon completion of a content purchase transaction, the purchased content item may be transmitted to device 630 via network connection 615 (if user preferences so specify). In this case, the purchased content item may be transmitted to device 601 to be stored thereon. Alternatively, again depending upon user preferences, the content item may be stored on receiver 601 in a “locked” mode. In this case, upon completion of the purchase, unlock information (e.g., an unlock key, a license, or the like) may be transmitted to device 630 via network 615 and then transmitted to receiver 601 via connection 613 where the content item may be unlocked (i.e., made available for playback and/or transfer to another device).

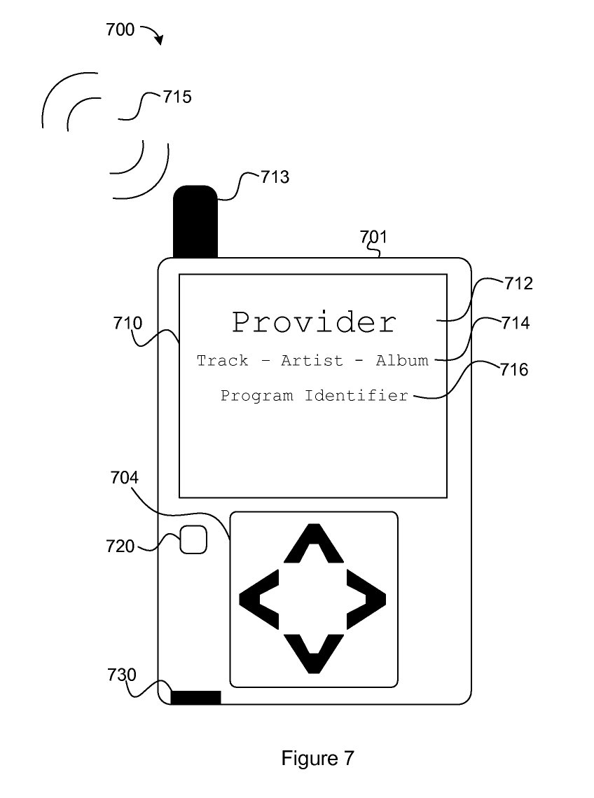

Turning now to FIG. 7, one embodiment of a broadcast content receiver device 701 comprising a purchase content button 720 is depicted. Device 701 may comprise a tuner 713 capable of receiving broadcasts in AM, FM, HD Radio®, satellite, television, or other broadcast content. Device 701 may comprise controls 704 to control the tuner and configuration of device 701. Device 701 may comprise a display 710 configured to display broadcast source information 712, content information 714 and/or program information 716. In an alternative embodiment, display 710 may be used to display video content such as a television program, movie, multimedia content, or the like. Device 701 may comprise a dock interface 730. Dock interface 730 may allow device 701 to be connected to another device, such as a personal computer, home media center, cellular phone, or the like.

Device 701 may comprise a “purchase content” input 720. Purchase content input 720 may be alternatively embodied as an input on a touch screen display 710, a menu selection on display 710, or the like. Upon selecting input 720, device 701 may be configured to generate a content purchase request. The content purchase request may comprise a user and content item identifier.

The content purchase request message may be transmitted from the device via network 715. Tuner 713 may be communicatively coupled to a wireless network, a Wi-Fi network, or other network. In this embodiment, the content purchase request message may be transmitted to a content purchase service via tuner 713. Where the connection to the network is intermittent, the content purchase message may be stored on device 701 until network connectivity is established. In addition, user preferences may specify that content purchase request messages be sent at a certain time and/or only using dock interface 730. In this case, the content purchase request message may be stored on device 701 until connected via dock interface 730 and/or a user specified upload time.

In another embodiment, tuner 713 and/or device 701 may not be capable of connecting to network 715. In this case, the content purchase request message may be stored on device 701 until the device is communicatively coupled to another device (not shown) via dock interface 730. When so connected, device 701 may be configured to use a network connection of the attached device (not shown) to transmit any purchase request messages stored thereon.

It will be obvious to those having skill in the art that many changes may be made to the details of the above-described embodiments without departing from the underlying principles of the invention. The scope of the present invention should, therefore, be determined only by the following claims.

I claim:

1. A method for providing a content purchase service to allow a user to purchase a content item in a single step, the method comprising:
receiving a request to purchase a content item being contemporaneously presented on a broadcast content receiver, the request comprising a user identifier and a content item identifier, wherein the user identifier and the content item identifier are automatically obtained from the broadcast content receiver responsive to a user selection of a purchase content input of the broadcast content receiver;
accessing a user account using the user identifier;
identifying the content item using the content item identifier;
selecting a content item for purchase based upon user preferences stored in the user account; and
delivering the content item using a delivery method specified in the user preferences.

2. The method of claim 1, wherein the content item identifier comprises a broadcast station identifier, a location of the broadcast receiver, and a timestamp.

3. The method of claim 2, wherein the location of the broadcast receiver comprises a GPS coordinate.

4. The method of claim 2, wherein identifying the content comprises identifying a broadcast station and querying a broadcast schedule to identify the content item.

5. The method of claim 4, wherein querying the broadcast schedule to identify the content comprises obtaining a playlist from the broadcast station and identifying the content item in the playlist using the timestamp.

6. The method of claim 1, wherein the content item identifier comprises a track name and an artist name.

7. The method of claim 6, wherein the content item identifier further comprises an artist name and an album name.

8. The method of claim 1, further comprising identifying a content provider to provide the content and purchasing the content from the content provider.

9. The method of claim 8, wherein purchasing the content item comprises transferring a payment from a user payment source to the content provider.

10. The method of claim 1, wherein delivering the content item comprises transferring the content item to a device over a network.

11. The method of claim 10, wherein the device is the broadcast content receiver.

12. The method of claim 10, wherein the device is a home media center.

13. The method of claim 1, wherein delivering the content item comprises one or more of providing a download link to the user, adding the content item to a shopping cart, adding the content item to a selection list at a content provider, and adding the item to a selection list associated with the user account.

14. The method of claim 1, wherein delivering the content item comprises unlocking a content item stored on the broadcast content receiver.

15. The method of claim 1, wherein delivering the content item comprises providing the content item on a tangible media.

16. The method of claim 1, wherein the content item is one selected from the group consisting of music content, television content, video content, motion picture content, and multimedia content.

17. The method of claim 1, wherein the user preferences specify a preferred content item codec.

18. The method of claim 1, wherein the user preferences comprise content DRM preferences.

19. A computer-readable medium comprising program code for causing a computer to perform a method for providing a content purchase service to allow a user to purchase a content item in a single step, the method comprising:
receiving a request to purchase content being contemporaneously presented on a broadcast content receiver, the request comprising a user identifier and a content item identifier, wherein the user identifier and the content item identifier are automatically obtained from the broadcast content receiver responsive to a user selection of a purchase content input of the broadcast content receiver;
accessing a user account using the user identifier;
identifying a content item using the content item identifier;
selecting a content item for purchase using user preferences associated with the user account;
identifying a content item provider to provide the content item; and
delivering the content item using a delivery method specified in the user preferences.

20. The computer-readable medium of claim 18, wherein the content item identifier comprises a broadcast station identifier, a location of the broadcast receiver, and a timestamp.

21. A device for purchasing a content item in a single step, comprising:
a broadcast content receiver; and
a content purchase input communicatively coupled to the broadcast content receiver, wherein, responsive to a user selection of the input, the broadcast content receiver is configured to generate a content purchase request comprising a user identifier automatically obtained from a data store and a content item identifier to identify a content item contemporaneously presented on the broadcast content receiver; and
a communication module communicatively coupled to the broadcast content receive configured to transmit the content purchase request to a content purchase service.

22. The device of claim 21, wherein the content item identifier comprises a station identifier, a timestamp, and a location of the broadcast receiver device.

23. The device of claim 21, further comprising a location receiver communicatively coupled to the broadcast content receiver, wherein the content item identifier comprises a station identifier, a timestamp, and a location identifier automatically obtained from the location receiver.

24. The device of claim 21, wherein the communication module is a device synchronization module, and wherein the broadcast content receiver is configured to transmit the content purchase request to the content purchase service using a second device communicatively coupled to the broadcast content receiver via the device synchronization module.

25. The device of claim 21, where the communication module comprises a wireless communication module, and wherein the broadcast content receiver is configured to transmit the content purchase request to the content purchase service using a second device communicatively coupled to the broadcast content receiver via the wireless communication module.
